(19) United States
(12) Patent Application Publication
(10) Pub. No.: US 2021/0001858 A1
(43) Pub. Date: Jan. 7, 2021

(54) LANE CHANGE CONTROL DEVICE AND METHOD FOR AUTONOMOUS VEHICLE

(71) Applicants: HYUNDAI MOTOR COMPANY, Seoul (KR); KIA MOTORS CORPORATION, Seoul (KR)

(72) Inventor: Dong Hoon KANG, Seoul (KR)

(73) Assignees: HYUNDAI MOTOR COMPANY, Seoul (KR); KIA MOTORS CORPORATION, Seoul (KR)

(21) Appl. No.: 16/684,090

(22) Filed: Nov. 14, 2019

(30) Foreign Application Priority Data
Jul. 1, 2019 (KR) 10-2019-0078879

(51) Int. Cl. B60W 30/18; G05D 1/00; G06N 3/08; G06N 3/04

(52) U.S. Cl. CPC B60W 30/18163; G05D 1/0088; G06N 3/08; B60W 2710/20; G05D 2201/0213; B60W 2550/30; B60W 2550/302; G06N 3/0445

(57) ABSTRACT

A lane change control device and a method for an autonomous vehicle improve safety and accuracy in changing lanes on a road. In particular, the lane change control device includes: a learning device that learns an environment in which the autonomous vehicle is able to change lanes on a road; and a controller that controls a lane change of the autonomous vehicle, based on a learned result of the learning device.

### CROSS-REFERENCE TO RELATED APPLICATION

This application claims priority to and the benefit of Korean Patent Application No. 10-2019-0078879, filed on Jul. 1, 2019, the entire contents of which are incorporated herein by reference.

### FIELD

The present disclosure relates to a technology for controlling a lane change of an autonomous vehicle based on deep learning.

### BACKGROUND

The statements in this section merely provide background information related to the present disclosure and may not constitute prior art.

In general, deep learning or deep neutral network is a form of machine learning algorithms, having multiple layers which is arranged between input and output and implemented with an Artificial Neural Network (ANN) . The artificial neural network may include a Convolution Neural Network (CNN) or a Recurrent Neural Network (RNN) as desired for a specific structure, a problem to be solved, or an objective.

Data input to the convolution neural network is classified into a training set and a test set. The convolution neural network learns a weight of the neural network through the training set and identifies the learned result through the test set.

In the convolution neural network, when data is input, an operation is performed step by step from an input layer to a hidden layer, and the result is output. In this process, the input data passes through all nodes only once.

When the input data passes through all the nodes only once, this means that the structure does not take into account the sequence of data, that is, a temporal aspect. As a result, the convolution neural network performs learning regardless of the chronological order of the input data.

In contrast, the recurrent neural network has a structure in which a result of a hidden layer is input to the hidden layer again. This structure means that the chronological order of input data is taken into account.

Lane change control technology for an autonomous vehicle in the related art performs a lane change when the space (the access space) between a forward vehicle and a rearward vehicle in a lane (a target lane) to which the autonomous vehicle is to move exceeds a reference value, that is, only when the autonomous vehicle is not impeded by the forward vehicle and the rearward vehicle when changing lanes. Therefore, the lane change control technology cannot perform a lane change in the case of urban driving or traffic jam where an access space exceeding the reference value is rarely generated.

### SUMMARY

The present disclosure has been made to address the above-mentioned problems occurring in the prior art while advantages achieved by the prior art are maintained intact.

An aspect of the present disclosure provides a lane change control device and method for enabling an autonomous vehicle to change lanes even in the case of urban driving or traffic jam, by performing deep learning based on various types of data that has to be taken into account when the autonomous vehicle changes the lanes and controlling the lane change of the autonomous vehicle based on the learned result.

The technical problems to be solved by the present disclosure are not limited to the aforementioned problems, and any other technical problems not mentioned herein will be clearly understood from the following description by those skilled in the art to which the present disclosure pertains. Also, it will be easily understood that the aspects and advantages of the present disclosure can be accomplished by the means set forth in the appended claims and combinations thereof.

According to an aspect of the present disclosure, a lane change control device of an autonomous vehicle includes: a learning device that learns an environment in which the autonomous vehicle is able to make a lane change and a controller that controls the lane change of the autonomous vehicle, based on a learned result of the learning device.

The controller may control the lane change of the autonomous vehicle, considering whether a rearward vehicle travelling on a target lane yields to the autonomous vehicle, even when it is determined that the autonomous vehicle is able to make the lane change.

The controller may stop the autonomous vehicle and may re-determine whether the autonomous vehicle is able to make the lane change, when the rearward vehicle does not yield to the autonomous vehicle during the lane change of the autonomous vehicle.

The controller may determine that the rearward vehicle yields to the autonomous vehicle, when a speed of the rearward vehicle is reduced. The controller may determine that the rearward vehicle does not yield to the autonomous vehicle, when the speed of the rearward vehicle is maintained or increased.

The controller may determine whether the rearward vehicle yields to the autonomous vehicle, additionally considering whether signal lamps of the rearward vehicle flash on and off.

The learning device may consider a case where a rearward vehicle travelling in a target lane yields to the autonomous vehicle as the environment in which the autonomous vehicle is able to make the lane change.

The learning device may learn the environment in which the autonomous vehicle is able to make the lane change, by receiving an input of at least one of speeds of a forward vehicle and a rearward vehicle that are travelling in a target lane, whether signal lamps of the forward vehicle flash on and off, whether brake lamps of the forward vehicle light up, whether signal lamps of the rearward vehicle flash on and off, or a heading angle of the autonomous vehicle. The learning device may learn based on a Recurrent Neural Network (RNN).

According to another aspect of the present disclosure, a lane change control method of an autonomous vehicle includes learning, by a learning device, an environment in which the autonomous vehicle is able to change lanes and controlling, by a controller, a lane change of the autonomous vehicle based on a learned result of the learning device.

The controlling of the lane change of the autonomous vehicle may include controlling the lane change of the autonomous vehicle, considering whether a rearward vehicle travelling on a target lane yields to the autonomous vehicle, even when it is determined that the autonomous vehicle is able to change the lanes.

The controlling of the lane change of the autonomous vehicle may further include stopping the autonomous vehicle and re-determining whether the autonomous vehicle is able to change the lanes, when the rearward vehicle does not yield to the autonomous vehicle during the lane change of the autonomous vehicle.

The re-determining of whether the autonomous vehicle is able to change the lanes may include determining that the rearward vehicle yields to the autonomous vehicle, when a speed of the rearward vehicle is reduced and determining that the rearward vehicle does not yield to the autonomous vehicle, when the speed of the rearward vehicle is maintained or increased.

The determining that the rearward vehicle yields to the autonomous vehicle may include determining that the rearward vehicle yields to the autonomous vehicle, when it is detected that signal lamps of the rearward vehicle flash on and off while the speed of the rearward vehicle is reduced.

The learning of the environment may include considering a case where a rearward vehicle travelling in a target lane yields to the autonomous vehicle as the environment in which the autonomous vehicle is able to make the lane change.

The learning of the environment may include learning the environment in which the autonomous vehicle is able to change the lanes, by receiving an input of at least one of speeds of a forward vehicle and a rearward vehicle that are travelling on a target lane, whether signal lamps of the forward vehicle flash on and off, whether brake lamps of the forward vehicle light up, whether signal lamps of the rearward vehicle flash on and off, or a heading angle of the autonomous vehicle. The learning of the environment may be performed based on a Recurrent Neural Network (RNN).

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view illustrating a configuration of one form of a lane change control device of an autonomous vehicle;

FIG. 2 is a view illustrating a driving environment in which the lane change control device of the autonomous vehicle operates ;

FIG. 3 is a view illustrating a structure of an RNN included in the lane change control device of the autonomous vehicle;

FIG. 4 is a flowchart illustrating a lane change control method for an autonomous vehicle; and

FIG. 5 is a block diagram illustrating one form of a computing system for executing the lane change control method for the autonomous vehicle.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some embodiments of the present disclosure will be described in detail with reference to the exemplary drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

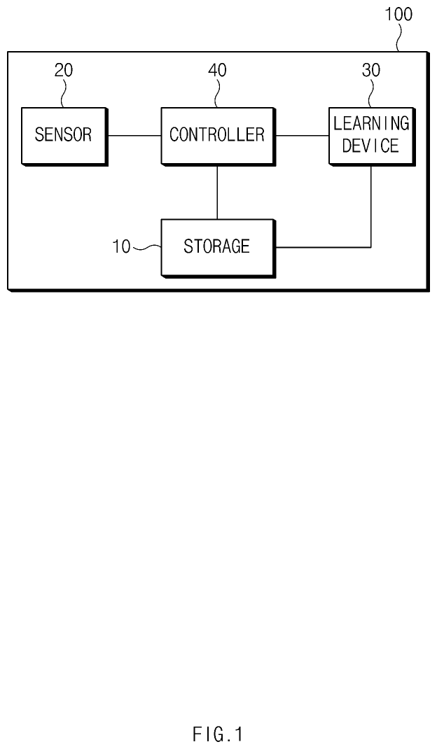

FIG. 1 is a view illustrating a configuration of a lane change control device of an autonomous vehicle according to an embodiment of the present disclosure.

As illustrated in FIG. 1, the lane change control device 100 of the autonomous vehicle may include: storage 10, a sensor 20, a learning device 30, and a controller 40. The components may be combined together to form one entity, or some of the components may be omitted, depending on a way of carrying out the lane change control device 100 of the autonomous vehicle according to the embodiment of the present disclosure. In particular, the learning device 30 may be integrated into the controller 40 and may be implemented to cause the controller 40 to perform a function of the learning device 30.

Hereinafter, the aforementioned components will be described in detail. The storage 10 may store various types of logic, algorithms, and programs that are desired in a process of performing deep learning based on various types of data that has to be taken into account when the autonomous vehicle makes a lane change on a road and controlling the lane change of the autonomous vehicle based on the learned result.

In particular, the storage 10 may store a threshold value Pₐᵥₐᵢₗ that is used to determine whether a lane change is attempted, based on an output of a Recurrent Neural Network (RNN) in which learning is performed to a predetermine level or completely. The autonomous vehicle may attempt to change lanes when the output P of the RNN exceeds the threshold value (P>Pₐᵥₐᵢₗ).

The storage 10 may include at least one type of storage medium among memories of a flash memory type, a hard disk type, a micro type, and a card type (e.g., a Secure Digital (SD) card or an eXtream Digital (XD) card) and memories of a Random Access Memory (RAM) type, a static RAM (SRAM) type, a Read-Only Memory (ROM) type, a Programmable ROM (PROM) type, an Electrically Erasable PROM (EEPROM) type, a Magnetic RAM (MRAM) type, a magnetic disk type, and an optical disk type.

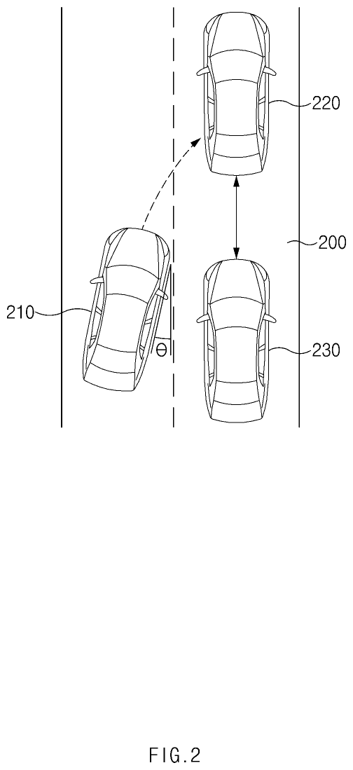

The sensor 20 may measure the speed of other vehicle that is travelling in the vicinity of the autonomous vehicle. That is, the sensor 20 may measure the speeds of a forward vehicle 220 and a rearward vehicle 230 that are located in a target lane 200 as illustrated in FIG. 2.

The sensor 20 may measure the heading angle θ of an autonomous vehicle 210.

The sensor 20 may detect whether signal lamps of the forward vehicle 220 flash on and off and whether brake lamps of the forward vehicle 220 light up.

The sensor 20 may detect whether signal lamps of the rearward vehicle 230 flash on and off and whether brake lamps of the rearward vehicle 230 light up.

The sensor 20 may include a Light Detection And Ranging (LiDAR) sensor, a camera, a Radio Detecting And Ranging (RaDAR) sensor, an ultrasonic sensor, and the like.

For reference, the LiDAR sensor, which is a kind of environmental awareness sensor, is mounted in the autonomous vehicle 210 to emit a laser beam forward while rotating and measure position coordinates of a reflector based on the time during which the laser beam reflects back from the reflector.

The camera is mounted on a front side, a rear side, a left side, and a right side of the autonomous vehicle 210 to take an image including lanes, vehicles, and obstacles around the autonomous vehicle 210. The camera may take an image of the signal lamps and the brake lamps of the forward vehicle 220 on the target lane 200. Furthermore, the camera may take an image of the signal lamps of the rearward vehicle 230.

The RaDAR sensor, after radiating electromagnetic waves, receives the electromagnetic waves reflected from an object and measures the distance from the object, the direction of the object, and the like. The RaDAR sensor may be mounted on a front bumper of the autonomous vehicle 210 and on a rear side thereof. The RaDAR sensor is capable of recognizing an object located a long distance away from the RaDAR and is rarely affected by the weather.

The learning device 30 may learn a lane change environment (an environment in which the autonomous vehicle 210 is able to change lanes), based on various types of data that has to be taken into account when a lane change is performed based on the RNN. The various types of data may include at least one of the speeds of the forward vehicle 220 and the rearward vehicle 230 that are travelling on the target lane 200, whether the signal lamps of the forward vehicle 220 flash on and off, whether the brake lamps of the forward vehicle 220 light up, whether the signal lamps of the rearward vehicle 230 flash on and off, and the heading angle θ of the autonomous vehicle 210.

The learning device 30 may generate a lane change model of the autonomous vehicle 210 as the learned result. The lane change model includes a lane change in the case where the autonomous vehicle 210 is able to change lanes when the rearward vehicle 230 yields to the autonomous vehicle 210 even though the autonomous vehicle 210 is impeded by the forward vehicle 220 and the rearward vehicle 230, as well as a lane change in the case where the autonomous vehicle 210 is not impeded by the forward vehicle 220 and the rearward vehicle 230 when changing lanes.

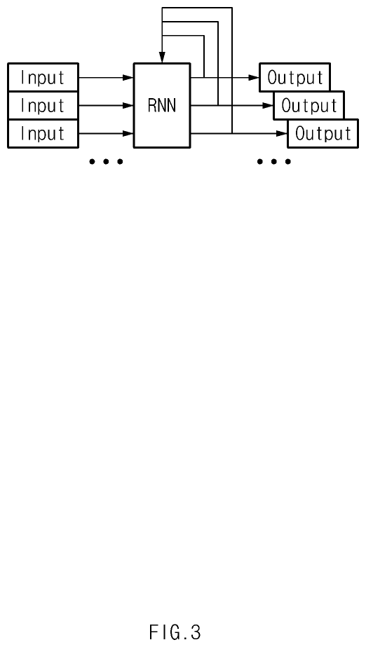

The learning device 30 may include, for example, an RNN having a structure as illustrated in FIG. 3. The RNN may take into account the chronological order of input data because the RNN has a structure in which an output of a hidden layer is input to the hidden layer again.

The controller 40 performs overall control to enable the above-described components to normally perform the functions thereof. The controller 40 may be implemented in a hardware or software form, or may be implemented in a form in which hardware and software are combined. The controller 40 may be implemented with, but is not limited to, a microprocessor.

In particular, the controller 40 may perform various controls that are desired in a process of performing deep learning based on various types of data that has to be taken into account when the autonomous vehicle 210 changes lanes and controlling the lane change of the autonomous vehicle 210 based on the learned result.

As illustrated in FIG. 2, a driving environment to which the lane change control device 100 of the autonomous vehicle according to the embodiment of the present disclosure is applied is targeted at an environment in which the autonomous vehicle 210 is unable to change lanes when the rearward vehicle 230 does not yield to the autonomous vehicle 210 (when the rearward vehicle 230 does not reduce the speed).

Accordingly, a success or failure in a lane change may be determined depending on whether the rearward vehicle 230 yields to the autonomous vehicle 210, even though the controller 40 determines that the autonomous vehicle 210 is able to change lanes, based on the learned result of the learning device 30. That is, when the rearward vehicle 230 yields to the autonomous vehicle 210, the controller 40 may immediately complete a lane change of the autonomous vehicle 210. However, when the rearward vehicle 230 does not yield to the autonomous vehicle 210, the controller 40 has to stop the autonomous vehicle 210 making an attempt to enter the space ahead of the rearward vehicle 230 and re-determine whether the autonomous vehicle 210 is able to change lanes. The determination process may be repeatedly performed until the autonomous vehicle 210 completely changes lanes.

Consequently, the controller 40 may lead the rearward vehicle 230 to yield to the autonomous vehicle 210 while allowing the autonomous vehicle 210 to slowly enter the space between the forward vehicle 220 and the rearward vehicle 230. When the rearward vehicle 230 does not yield to the autonomous vehicle 210, the controller 40 may stop the autonomous vehicle 210, and when the rearward vehicle 230 yields to the autonomous vehicle 210, the controller 40 may resume the entrance of the autonomous vehicle 210 into the space and may complete the lane change.

Hereinafter, operations of the controller 40 in connection with a lane change of the autonomous vehicle 210 will be described in detail.

The controller 40 may apply various types of data measured by the sensor 20 to a learned result of the learning device 30 and may determine whether the autonomous vehicle 210 is able to change lanes.

When it is determined that the autonomous vehicle 210 is able to change lanes, the controller 40 monitors the speed of the rearward vehicle 230 on the target lane 200 through the sensor 20 while allowing the autonomous vehicle 210 to enter the target lane 200. At this time, the controller 40 may additionally monitor whether the signal lamps of the rearward vehicle 230 flash on and off.

When the rearward vehicle 230 reduces the speed or stops, the controller 40 determines that the rearward vehicle 230 yields to the autonomous vehicle 210, and completes a lane change. When the speed of the rearward vehicle 230 is maintained or increased, the controller 40 determines that a driver of the rearward vehicle 230 has no intention to yield to the autonomous vehicle 210, and stops the autonomous vehicle 210.

The controller 40 applies various types of data measured by the sensor 20 in the current stop position to the learned result of the learning device 30 and re-determines whether the autonomous vehicle 210 is able to change lanes. Thereafter, the above-described processes are repeatedly performed.

Through the above-described processes, the controller 40 may safely control a lane change of the autonomous vehicle 210 even in a driving environment in which vehicles are concentrated.

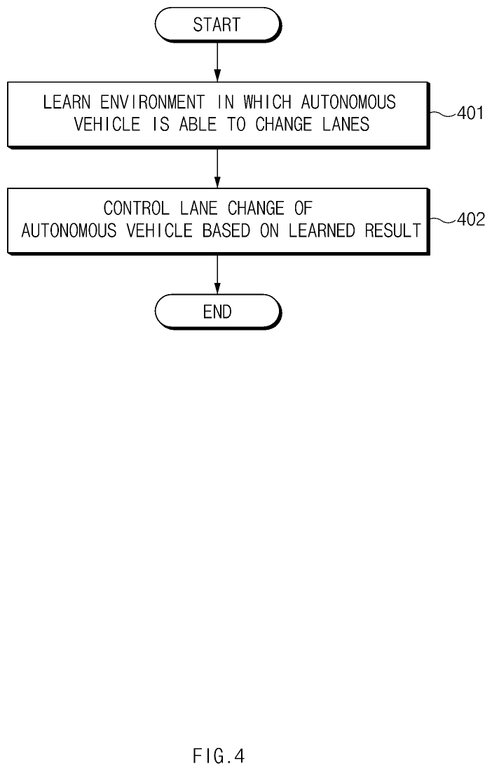

FIG. 4 is a flowchart illustrating a lane change control method for an autonomous vehicle according to an embodiment of the present disclosure.

First, the learning device 30 learns an environment in which the autonomous vehicle is able to change lanes (401). That is, the learning device 30 learns a case where the autonomous vehicle is able to change lanes when a rearward vehicle travelling in a target lane yields to the autonomous vehicle, as the environment in which the autonomous vehicle is able to change the lanes. At this time, the learning device 30 may receive an input of at least one of the speed of a forward vehicle travelling in the target lane, the speed of the rearward vehicle, whether signal lamps of the forward vehicle flash on and off, whether brake lamps of the forward vehicle light up, whether signal lamps of the rearward vehicle flash on and off, and the heading angle of the autonomous vehicle to learn the environment in which the autonomous vehicle is able to change the lanes.

Thereafter, the controller 40 controls a lane change of the autonomous vehicle, based on the learned result of the learning device (402). That is, even when it is determined that the autonomous vehicle is able to change the lanes, the controller 40 controls the lane change of the autonomous vehicle, considering whether the rearward vehicle travelling on the target lane yields to the autonomous vehicle.

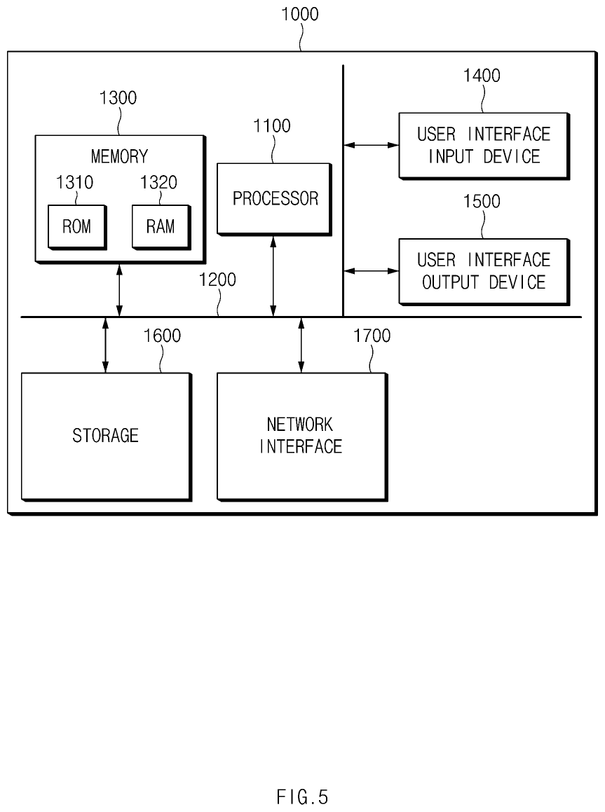

FIG. 5 is a block diagram illustrating a computing system for executing the lane change control method for the autonomous vehicle according to an embodiment of the present disclosure.

Referring to FIG. 5, the above-described lane change control method for the autonomous vehicle according to the embodiment of the present disclosure may be implemented through the computing system. The computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, or a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The lane change control device and method for the autonomous vehicle according to the embodiments of the present disclosure performs deep learning based on various types of data that has to be taken into account when the autonomous vehicle changes lanes, and controls the lane change of the autonomous vehicle based on the learned result, thereby enabling the autonomous vehicle to change lanes even in the case of urban driving or traffic jam.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. A lane change control device of an autonomous vehicle, comprising:
a learning device configured to learn an environment in which the autonomous vehicle is able to make a lane change; and
a controller configured to control the lane change of the autonomous vehicle, based on a learned result of the learning device.

2. The lane change control device of claim 1, wherein the controller is configured to control the lane change of the autonomous vehicle, considering whether a rearward vehicle travelling in a target lane yields to the autonomous vehicle, even when it is determined that the autonomous vehicle is able to make the lane change.

3. The lane change control device of claim 2, wherein the controller is configured to stop the autonomous vehicle and re-determine whether the autonomous vehicle is able to make the lane change when the rearward vehicle does not yield to the autonomous vehicle during the lane change of the autonomous vehicle.

4. The lane change control device of claim 3, wherein the controller is configured to determine that the rearward vehicle yields to the autonomous vehicle when a speed of the rearward vehicle is reduced, and the controller is configured to determine that the rearward vehicle does not yield to the autonomous vehicle when the speed of the rearward vehicle is maintained or increased.

5. The lane change control device of claim 4, wherein the controller is configured to determine whether the rearward vehicle yields to the autonomous vehicle, additionally considering whether signal lamps of the rearward vehicle flash on and off.

6. The lane change control device of claim 1, wherein the learning device is configured to consider a case where a rearward vehicle travelling in a target lane yields to the autonomous vehicle as the environment in which the autonomous vehicle is able to make the lane change.

7. The lane change control device of claim 1, wherein the learning device is configured to learn the environment in which the autonomous vehicle is able to make the lane change, by receiving an input of at least one of speeds of a forward vehicle and a rearward vehicle that are travelling in a target lane, whether signal lamps of the forward vehicle flash on and off, whether brake lamps of the forward vehicle light up, whether signal lamps of the rearward vehicle flash on and off, or a heading angle of the autonomous vehicle.

8. The lane change control device of claim 1, wherein the learning device learns based on a Recurrent Neural Network (RNN).

9. A lane change control method for an autonomous vehicle, comprising:
learning, by a learning device, an environment in which the autonomous vehicle is able to make a lane change; and
controlling, by a controller, the lane change of the autonomous vehicle based on a learned result of the learning device.

10. The lane change control method of claim 9, wherein controlling of the lane change of the autonomous vehicle includes:
controlling the lane change of the autonomous vehicle, considering whether a rearward vehicle travelling in a target lane yields to the autonomous vehicle, even when it is determined that the autonomous vehicle is able to make the lane change.

11. The lane change control method of claim 10, wherein controlling of the lane change of the autonomous vehicle further includes:
stopping the autonomous vehicle and re-determining whether the autonomous vehicle is able to make the lane change, when the rearward vehicle does not yield to the autonomous vehicle during the lane change of the autonomous vehicle.

12. The lane change control method of claim 11, wherein re-determining of whether the autonomous vehicle is able to make the lane change includes:
determining that the rearward vehicle yields to the autonomous vehicle, when a speed of the rearward vehicle is reduced; and
determining that the rearward vehicle does not yield to the autonomous vehicle, when the speed of the rearward vehicle is maintained or increased.

13. The lane change control method of claim 11, wherein determining that the rearward vehicle yields to the autonomous vehicle includes:
determining that the rearward vehicle yields to the autonomous vehicle, when it is detected that signal lamps of the rearward vehicle flash on and off while a speed of the rearward vehicle is reduced.

14. The lane change control method of claim 9, wherein learning of the environment includes:
considering a case where a rearward vehicle travelling in a target lane yields to the autonomous vehicle as the environment in which the autonomous vehicle is able to make the lane change.

15. The lane change control method of claim 9, wherein learning of the environment includes:
learning the environment in which the autonomous vehicle is able to make the lane change, by receiving an input of at least one of speeds of a forward vehicle and a rearward vehicle that are travelling in a target lane, whether signal lamps of the forward vehicle flash on and off, whether brake lamps of the forward vehicle light up, whether signal lamps of the rearward vehicle flash on and off, or a heading angle of the autonomous vehicle.

16. The lane change control method of claim 9, wherein the learning of the environment is performed based on a Recurrent Neural Network (RNN).
